(19) United States
(12) Patent Application Publication
(10) Pub. No.: US 2021/0083750 A1
(43) Pub. Date: Mar. 18, 2021

(54) Low Latency Beam Search and Dynamic Beamforming

(71) Applicant: Apple Inc., Cupertino, CA (US)

(72) Inventors: Galib A. MOHIUDDIN, San Jose, CA (US); Johnson O. Sebeni, Fremont, CA (US)

(21) Appl. No.: 17/015,692

(22) Filed: Sep. 9, 2020

Related U.S. Application Data
(60) Provisional application No. 62/899,377, filed on Sep. 12, 2019.

(51) Int. Cl. H04B 7/08; H04B 7/06; H04B 7/0456; H04B 17/309

(52) U.S. Cl. CPC H04B 7/086; H04B 17/309; H04B 7/0456; H04B 7/0639

(57) ABSTRACT

Methods and devices for performing an offline beam search. The methods include receiving a radio frequency signal comprising a reference signal, wherein the radio frequency signal corresponds to a transmitter beam, projecting the radio frequency signal on orthogonal signal subspaces and storing the projected signals and performing a beam search to identify a receiver beam for the transmitter beam using the projected signals, wherein the beam search is performed offline.

### BACKGROUND

A user equipment (UE) may establish a connection to at least one of multiple different networks or types of networks. In some networks, signaling between the UE and a base station of the network may occur over the millimeter wave (mmWave) spectrum. Signaling over the mmWave spectrum may be achieved by beamforming which is an antenna technique used to transmit or receive a directional signal. On the transmitting side, beamforming may include propagating a directional signal. A beamformed signal may be referred to as a transmitter beam. On the receiving side, beamforming may include configuring a receiver to listen in a direction of interest. The spatial area encompassed by the receiver when listening in a direction of interest may be referred to as a receiver beam.

Establishing and/or maintaining a communication link between the UE and the network over the mmWave spectrum may include a process referred to as beam management. Beam management may refer to various operations performed on both the network side and the UE side that are intended to align a transmitter beam and a receiver beam. When aligned, the transmitter beam and the receiver beam form a beam pair that may be utilized for a data transfer.

For downlink communications, beam management on the UE side may include selecting a receiver beam that is adequately aligned with a particular transmitter beam. The selection may be based on measurement data collected by the UE. For example, some conventional beam management techniques may include the network frequently transmitting reference signals and the UE adjusting its receiver beam based on measurement data corresponding to the reference signals. However, this adds signaling overhead and increases the number of operations performed by the UE during beam management. Consequently, this increases the power cost associated with beam management and limits the time available for the downlink data transfer.

Other conventional beam management mechanisms may utilize designated measurement opportunities. However, measurement opportunities are only configured for limited durations. As a result, only a subset of potential receiver beams may be evaluated and considered for selection. Further, to compensate for the time limited measurement opportunities, conventional beam management mechanisms utilize wider receiver beams. However, wider receiver beams provide pessimistic measurement data and cause the performance of the communication link to degrade. Accordingly, conventional beam management mechanisms for receiver beam selection are inefficient and/or do not provide optimal performance.

### SUMMARY

Some exemplary embodiments relate to a method performed by a user equipment (UE). The method includes receiving a radio frequency signal comprising a reference signal, wherein the radio frequency signal corresponds to a transmitter beam, projecting the radio frequency signal on orthogonal signal subspaces and storing the projected signals and performing a beam search to identify a receiver beam for the transmitter beam using the projected signals, wherein the beam search is performed offline.

Further exemplary embodiments relate to a user equipment (UE) that includes a plurality of antennas configured to receive a radio frequency signal comprising a reference signal and corresponding to a transmitter beam and a plurality of receive chains, wherein a number of receive chains is less than a number of antennas. The UE also includes a baseband processor configured to perform operations. The operations include receiving the radio frequency signal, projecting the radio frequency signal on orthogonal signal subspaces and storing the projected signals and performing a beam search to identify a receiver beam for the transmitter beam using the projected signals, wherein the beam search is performed offline.

Still other exemplary embodiments relate to a baseband processor configured to perform operations. The operations include receiving a radio frequency signal comprising a reference signal, wherein the radio frequency signal corresponds to a transmitter beam, projecting the radio frequency signal on orthogonal signal subspaces and storing the projected signals and performing a beam search to identify a receiver beam for the transmitter beam using the projected signals, wherein the beam search is performed offline.

### BRIEF DESCRIPTION OF THE DRAWINGS

FIG. 1A shows an example of three antenna modules and their corresponding radiation patterns.

FIG. 1B shows an example of the directions in which an antenna module may propagate a transmitter beam.

FIG. 1C shows examples of various receiver beam configurations.

FIG. 1D shows an example of a subset of receiver beams that may be included in an exemplary codebook.

FIG. 2 shows an exemplary network arrangement according to various exemplary embodiments.

FIG. 3 shows an exemplary UE according to various exemplary embodiments.

FIG. 4 shows an exemplary receiver beam selection method according to various exemplary embodiments.

FIG. 5 shows an exemplary arrangement of a transmitting device and a receiving device according to various exemplary embodiments.

FIG. 6 shows an example of the configuration of an angle of arrival (AoA) for a receiver beam selected based on the codebook and an example of the configuration of the AoA for a dynamic receiver beam.

### DETAILED DESCRIPTION

The exemplary embodiments may be further understood with reference to the following description and the related appended drawings, wherein like elements are provided with the same reference numerals. The exemplary embodiments describe a device, system and method to improve beam management at a receiving device by implementing mechanisms for a low latency receiver beam search and dynamic beamforming.

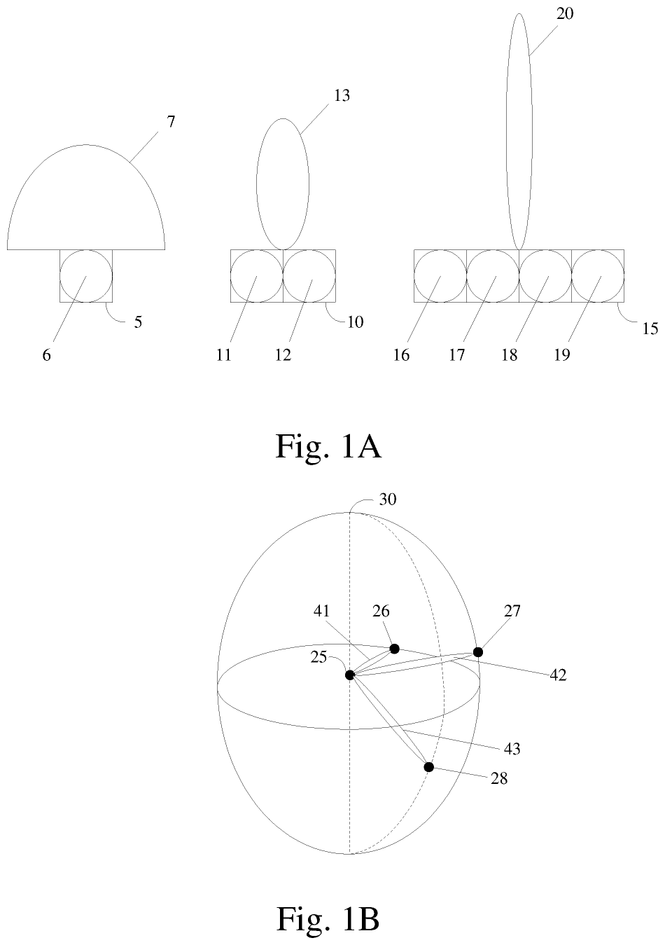

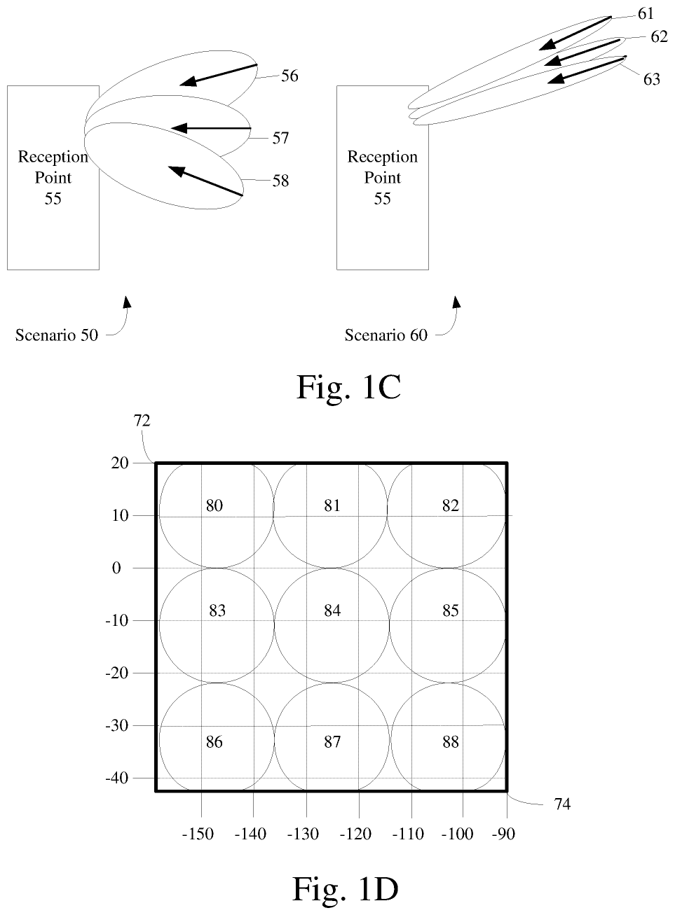

Beamforming is an antenna technique that is utilized to transmit or receive a directional signal. From the perspective of a transmitting device, beamforming may refer to propagating a directional signal. Throughout this description, a beamformed signal may be referred to as a transmitter beam. A transmitter beam may be generated by having a plurality of antenna elements radiate the same signal. Increasing the number of antenna elements radiating the signal decreases the width of the radiation pattern and increases the gain. As will be described below with regard to FIGS. 1A and 1B, a transmitter beam may vary in width and be propagated in any of a plurality of directions.

From the perspective of a receiving device, beamforming may refer to tuning a receiver to listen to a direction of interest. Throughout this description, the spatial area encompassed by the receiver listening in the direction of interest may be referred to as a receiver beam. The receiver beam may be generated by configuring the parameters of a spatial filter on a receiver antenna array to listen in a direction of interest and filter out any noise from outside the direction of interest. As will be described below with regard to FIG. 1C, a receiver beam may also vary in width and be directed in any of a plurality of different directions of interest.

The exemplary embodiments are described with regard to the receiving device being a user equipment (UE). However, the use of a UE is provided for illustrative purposes. The exemplary embodiments may be utilized with any electronic component that is configured with the hardware, software, and/or firmware to perform beamforming. Therefore, the UE as described herein is used to represent any electronic component that is capable of beamforming.

The exemplary embodiments are also described with regard to the transmitting device being a next generation Node B (gNB) of a 5G New Radio (NR) network. The UE and the 5G NR network may communicate via the gNB over the millimeter wave (mmWave) spectrum. The mmWave spectrum is comprised of frequency bands that each have a wavelength of 1-10 millimeters. The mmWave frequency bands may be located between, approximately, 10 gigahertz (GHz) and 300 GHz. However, the use of the gNB, the 5G NR network and mmWave spectrum is provided for illustrative purposes. The exemplary embodiments may apply to any devices that are configured to transmit a transmitter beam and/or use a receiver beam to receive a transmitter beam.

Establishing and/or maintaining a communication link over the mmWave spectrum may include a process referred to as beam management. Beam management is performed to align a transmitter beam and a receiver beam to form a beam pair that may be utilized for a data transfer. The performance of the beam pair may correlate to the accuracy of the alignment between the transmitter beam and the receiver beam. For any of a variety of different factors, the beam pair may become misaligned. As a result, the performance of the communication link may degrade.

The term beam management may encompass various mechanisms and operations that may be performed on both the UE side and the network side. Beam management mechanisms may be utilized in various types of scenarios, including but not limited to, establishing a beam pair, a handover from a first base station to a second base station, transitioning between operating states (e.g., idle to connected mode), exiting a sleep mode utilized with a connected discontinuous reception (C-DRX) cycle, adjusting a receiver beam relative to a transmitter beam based on measurement data, etc. Since beam management relates to aligning a transmitter beam and a receiver beam, beam management mechanisms may be utilized if the UE or the network determine a beam pair is to be used for a data transfer or in response to an indication that the performance of a currently configured beam pair is inadequate. However, any reference to a transmitter beam, a receiver beam, or beam management is for illustrative purposes. Different networks and/or entities may refer to similar concepts by different names.

For downlink communications, beam management on the UE side may include selecting an adequate receiver beam for a particular transmitter beam. This selection may be based, in part, on a codebook. Throughout this description, a codebook generally refers to a predetermined set of receiver beams. Each receiver beam included in the codebook may correspond to a different direction of interest. During operation, the UE may reference the codebook when selecting a receiver beam that is intended to be aligned with a particular transmitter beam. An example of a portion of a codebook will be described below with regard to FIG. 1D. However, reference to a codebook is for illustrative purposes. Different networks and/or entities may refer to a similar concept by a different name.

The exemplary embodiments are described with regard to performing an operation offline. Throughout this description offline refers to performing beam search or beamforming from beam measurements based on one or more projected received signals without the UE tuning its beamformer for every beam in the codebook in real-time. During offline beam search or beamforming, the UE can perform all normal procedures including data reception, tuning to a different frequency band, switching RF components off, entering a power-saving mode, etc. To provide an example, an offline receiver beam search for a particular transmitter beam and carrier frequency may occur when evaluating a codebook to select an adequate receiver beam for a particular transmitter beam while the UE is not listening to the frequency over which the particular transmitter beam was received. Accordingly, as will be demonstrated in further detail below, the offline receiver beam search enables the UE to evaluate potential receiver beams during various different types of scenarios, including but not limited to, during a data transfer, when operating in an idle state, when utilizing a sleep mode of a C-DRX cycle, etc. However, this example is provided for illustrative purposes and is not intended to limit the term offline to any particular operation or scenario.

The exemplary embodiments relate to improving receiver beam selection by implementing a low latency receiver beam search process. In a first aspect, the exemplary embodiments relate to performing a receiver beam search using a minimal amount of measurements. For example, the UE may project a received signal on a predetermined orthogonal signal space and then store the projected signal for subsequent operations. In a second aspect, the exemplary embodiments relate to utilizing the stored projected signal to perform an offline receiver beam search on one or more codebooks. Compared to conventional beam management mechanisms, the offline receiver beam search allows the UE to adequately evaluate a codebook without interrupting the downlink data transfer. In a third aspect, the exemplary embodiments relate to the UE performing dynamic beamforming based on the projected signal. Dynamic beamforming may establish a beam pair that is more precisely aligned and thus, increases the performance of the communication link. Each aspect of this exemplary low latency receiver beam search process may be used in conjunction with other currently implemented beam management mechanisms, future implementations of beam management mechanisms or independently from other beam management mechanisms.

FIG. 1A shows an example of three antenna modules 5, 10, 15 and their corresponding radiation patterns 7, 13, 20. As mentioned above, increasing the number of antenna elements radiating the signal decreases the width of the radiation pattern and increases the gain. Antenna module 5 includes a single antenna element 6 and generates the exemplary radiation pattern 7. Antenna module 10 includes two antenna elements 11, 12 and generates the exemplary radiation pattern 13. Antenna module 15 includes four antenna elements 16-19 and generates the exemplary radiation pattern 20. A comparison of the radiation patterns 7, 13, 20 illustrates the effects the number of antenna elements has on the geometry of the radiation pattern. For instance, in this example, antenna module 5 has the widest beam because antenna module 5 has the least amount of antenna elements (e.g., one). In contrast, antenna module 15 is able to generate the narrowest radiation pattern and provide the most gain because it is equipped with more antenna elements than antenna modules 5, 10. The above examples assume that each antenna element is propagating at the same phase a magnitude.

A transmitter beam may be propagated in any of a plurality of different directions. The direction in which a transmitter beam is propagated may be based on the phase and/or magnitude of the signal provided to each antenna element of the antenna module. Thus, the antenna module may be able to cover a particular area with a plurality of transmitter beams that are each propagated in a different direction by appropriately weighting the phase and/or magnitude of the signal provided to each antenna element for each transmitter beam.

FIG. 1B shows an example of the directions in which an antenna module 25 may propagate a transmitter beam. The antenna module 25 is located at the center of the spherical coordinate system 30 and represents a transmission point. Points 26, 27, 28 on the spherical coordinate system 30 each represent a different reception point. At a first time, antenna module 30 propagates transmitter beam 41 in the direction of reception point 26. At a second time, the antenna module 30 propagates transmitter beam 42 in the direction of the reception point 27. At a third time, the antenna module 30 propagates transmitter beam 43 in the direction of the reception point 28. Thus, the antenna module 30 may deliver transmitter beams 41, 42, 43 to receptions points 26, 27, 28 from the same transmission point despite the reception points 26, 27, 28 each being located in different horizontal and vertical directions relative to the antenna element 30. The above examples are merely provided for illustrative purposes. An antenna module may contain any appropriate number of antenna elements and a transmitter beam may be propagated in any direction.

FIG. 1C shows examples of various receiver beam configurations. As mentioned above, a receiver beam may be generated by configuring the parameters of a spatial filter on a receiver antenna array to listen for incoming signals from the direction of interest. Like the transmitter beam, the receiver beam may vary in width and be pointed in any direction.

There are two scenarios 50, 60 depicted in FIG. 1C. Scenario 50 shows a reception point 55 and three receiver beams 56, 57, 58. Each of the receiver beams 56, 57, 58 occur at a different time. For example, at a first time the reception point 55 may tune its receiver to generate the receiver beam 56. The width and angle of the receiver beam 56 may be based on the parameters of the spatial filter. Utilizing the receiver beam 56, the reception point 55 may receive signals incoming from this first direction of interest. Subsequently, at a second time, the reception point 55 may tune its receiver to generate the receiver beam 57. While the scenario 50 shows the receiver beams 56 and 57 being generally the same width, the angle of the receiver beam 57 is different than the angle of the receiver beam 56. Thus, with the receiver beam 57, the reception point 55 will receive signals incoming from this second direction of interest. At a third time, the reception point 55 may tune its receiver to generate the receiver beam 58. While the scenario 50 shows the receiver beams 56, 57, 58 being generally the same width, the angle of the receiver beam 58 is different than the angle of the receiver beam 56 and the receiver beam 57. Thus, with the receiver beam 58, the reception point 55 will receive signals incoming from this third direction of interest.

The link budget of a beam pair (e.g., transmitter beam and receiver beam) may correlate to the alignment and the width of the beam pair. At the reception point 55, beam management may include utilizing a plurality of receiver beams of different widths. For example, the receiver beams 56, 57, 58 may be used initially. Based on measurement data, one of the receiver beams 56, 57, 58 may be selected. Subsequently, the reception point 55 may utilize a plurality of narrower receiver beams in the general angular direction of the selected one of the receiver beams 56, 57, 58. Thus, the reception point 55 may initially utilize wider beams to search for incoming signals from a transmission point (not pictured). When an indication of the direction of the transmission point is identified, the reception point 55 may then utilize a plurality of narrower beams to establish a more precise alignment with the transmission point.

To provide an example, scenario 60 shows the reception point 55 utilizing three receiver beams 61, 62, 63 after the receiver beam 56 depicted in scenario 50 is selected based on measurement data. Like the receiver beams 56, 57, 58 depicted in scenario 50, each of the receiver beams 61, 62, 63 depicted in scenario 60 occur at a different time. For example, at a fourth time, the reception point 55 may tune its receiver to generate the receiver beam 61. At a fifth time, the reception point 55 may tune its receiver to generate the receiver beam 62. At a sixth time, the reception point 55 may tune its receiver to generate receiver beam 63. Subsequently, the reception point 55 may select one of the receiver beams 61, 62, 63 to receive signals via a transmission beam.

FIG. 1D shows an example of a subset of receiver beams that may be included in an exemplary codebook. As mentioned above, a receiver beam may vary in width and be pointed in any of a plurality of directions. This example depicts nine receiver beams 80-88. Each individual receiver beam has approximately the same width and is pointed in a different direction of interest relative to a reception point.

When the receiver beams 80-88 are combined with the remaining receiver beams in the codebook (not pictured), the cumulative set of receiver beams would generally cover the spherical space surrounding the reception point. To demonstrate this configuration, the nine receiver beams 80-88 are depicted on a graph where the y-axis 72 depicts the degrees of elevation relative to the reception point and the x-axis 74 depicts the angle of azimuth (AoA) relative to the reception point. In this example, the receiver beams 80-88 cover the angles of elevation from approximately −40 degrees to 20 degrees relative to the reception point and cover the AoA from approximately −150 degrees to −90 degrees relative to the reception point. Accordingly, each of the receiver beams 80-88 are depicted as having approximately a width of 22.5 degrees. However, depicting this portion of the codebook as a graph is only for illustrative purposes. From the perspective of the UE, the codebook may be stored as a set of data, in any format, that includes parameters that may provide the basis for the UE to generate each of the receiver beams 80-88 and the other remaining receiver beams in the codebook (not pictured).

To provide an example of receiver beam selection using a codebook, consider the following exemplary scenario. Initially, the UE and the currently camped base station participate in a signaling exchange. Based on the signaling exchange a transmitter beam may be selected. Thus, the UE may be aware that a transmitter beam is incoming from an approximate direction of interest. Accordingly, the UE may search the codebook and identify the predetermined parameters for a receiver beam that may be aligned with the transmitter beam. The UE may then generate the selected receiver beam and collect measurement data. The UE may repeat this process for a plurality of receiver beams by performing a beam sweep based on the codebook that covers a particular spatial area. The UE may then evaluate the receiver beams based on the collected measurement data and select a receiver beam from the codebook that adequately aligns with the transmitter beam. This exemplary scenario is provided for illustrative purposes, the UE may reference the codebook to generate a receiver beam in any appropriate scenario.

The UE may be equipped with one or more codebooks. For instance, a first codebook may have a first set of receiver beams with a first width, a second codebook may have a second set of receiver beams with a second width, etc. To provide an example, the first codebook may include receiver beams 56-58 shown in scenario 50 of FIG. 1C and the second codebook may include receiver beams 61-63 shown in scenario 60 of FIG. 1C. Further, as depicted in FIG. 1D, in some exemplary configurations, the receiver beams included in the codebook may not overlap. In other exemplary configurations, the receiver beams included in the codebook may overlap. The exemplary embodiments are not limited to a codebook that includes receiver beams with any particular characteristics. Since receiver beams may vary in width and may be pointed in any direction, a codebook may contain any appropriate number of receiver beams in any appropriate configuration. Accordingly, the exemplary embodiments apply to a codebook containing receiver beams that are based on any appropriate set of parameters.

FIGS. 1A-1D are not intended to limit the exemplary embodiments to any particular beamforming techniques. Instead, FIGS. 1A-1D are provided to demonstrate that beamforming may include transmitter beams of various widths that may be propagated in any direction and receiver beams of various widths that may be pointed in any direction. The exemplary embodiments may apply to a transmitter beam and a receiver beam being generated in any appropriate manner.

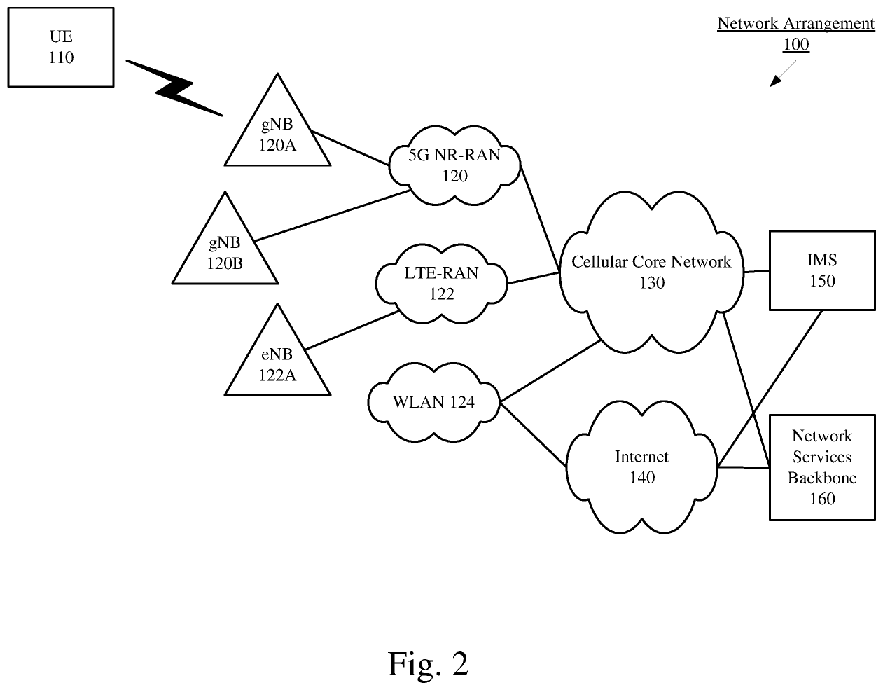

FIG. 2 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the networks with which the UE 110 may wirelessly communicate are a 5G New Radio (NR) radio access network (5G NR-RAN) 120, a LTE radio access network (LTE-RAN) 122 and a wireless local access network (WLAN) 124. However, it should be understood that the UE 110 may also communicate with other types of networks and the UE 110 may also communicate with networks over a wired connection. Therefore, the UE 110 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UE 110 may connect to the 5G NR-RAN via the gNB 120A. As mentioned above, the exemplary embodiments are related to mmWave functionality. Accordingly, the gNB 120A may be configured with the necessary hardware (e.g., antenna array), software and/or firmware to perform massive multiple in multiple out (MIMO) functionality. Massive MIMO may refer to a base station that is configured to generate a plurality of transmitter beams and a plurality of receiver beams for a plurality of UEs. During operation, the UE 110 may be within range of a plurality of gNBs. Thus, either simultaneously or alternatively, the UE 110 may also connect to the 5G NR-RAN via the gNB 120B. Reference to two gNBs 120A, 120B is merely for illustrative purposes. The exemplary embodiments may apply to any appropriate number of gNBs. Further, the UE 110 may communicate with the eNB 122A of the LTE-RAN 122 to transmit and receive control information used for downlink and/or uplink synchronization with respect to the 5G NR-RAN 120 connection.

Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., the gNB 120A of the 5G NR-RAN 120).

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

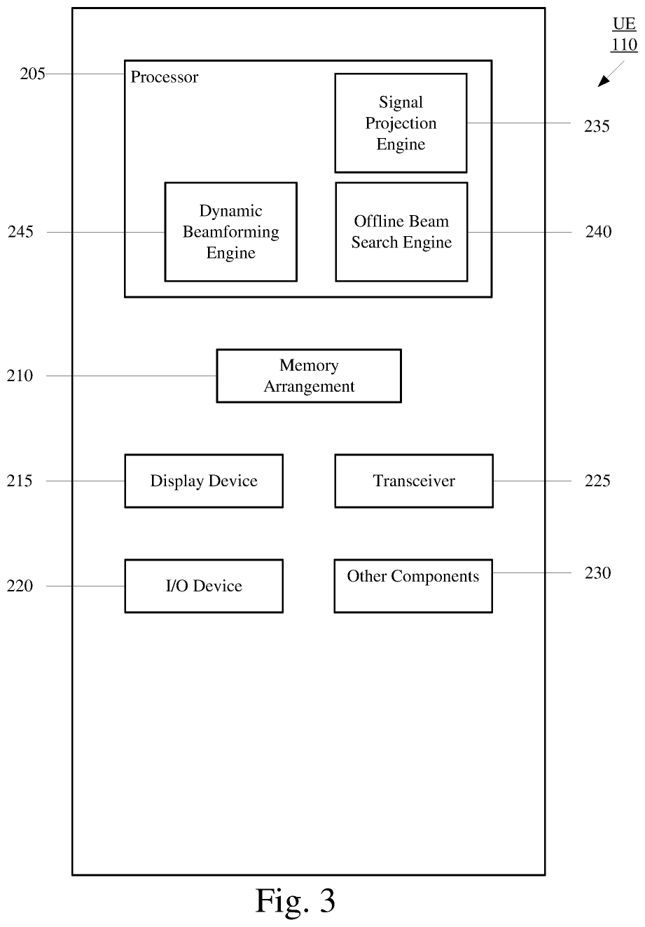

FIG. 3 shows an exemplary UE 110 according to various exemplary embodiments. The UE 110 will be described with regard to the network arrangement 100 of FIG. 2. The UE 110 may represent any electronic device and may include a processor 205, a memory arrangement 210, a display device 215, an input/output (I/O) device 220, a transceiver 225, an antenna panel 230 and other components 235. The other components 235 may include, for example, an audio input device, an audio output device, a battery that provides a limited power supply, a data acquisition device, ports to electrically connect the UE 110 to other electronic devices, etc.

The processor 205 may be configured to execute a plurality of engines of the UE 110. For example, the engines may include a signal projection engine 235, an offline beam search engine 240 and a dynamic beamforming engine 245. The signal projection engine 235 may project a received signal on a predetermined orthogonal signal space and then store the projected signal for subsequent operations. The offline beam search engine 240 may perform an offline search of a codebook based on the projected signal. The dynamic beamforming engine 245 may dynamically select a receiver beam that is not included in the codebook based on the projected signal.

The above referenced engines each being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the LTE-RAN 122, the WLAN 124, etc. Accordingly, the transceiver 225 may operate on a variety of different frequencies or channels (e.g., set of consecutive frequencies).

The UE 110 may be configured to be in one of a plurality of different operating states. One operating state may be characterized as RRC idle state, another operating state may be characterized as RRC inactive state and another operating state may be characterized as RRC connected state. RRC refers to the radio resource control (RRC) protocols. Those skilled in the art will understand that when the UE 110 is in RRC connected state, the UE 110 and the 5G NR-RAN 120 may be configured to exchange information and/or data. The exchange of information and/or data may allow the UE 110 to perform functionalities available via the network connection. Further, those skilled in the art will understand that when the UE 110 is connected to the 5G NR-RAN 120 and in RRC idle state, the UE 110 is generally not exchanging data with the network and radio resources are not being assigned to the UE 110 within the network. In RRC inactive state, the UE 110 maintains an RRC connection while minimizing signaling and power consumption. However, when the UE 110 is in RRC idle state or RRC inactive state, the UE 110 may monitor for information and/or data transmitted by the network. Throughout this description these terms are being used generally to describe states the UE 110 may be in when connected to any network and that exhibit the characteristics described above for the RRC idle, RRC connected and RRC inactive states.

The UE 110 may be configured to initiate beam management operations in any RRC operating state. For example, when the UE 110 is camped on a base station of the corresponding network in an RRC idle state or in an RRC inactive state, the UE 110 may not be able to receive data from the network. To receive beamformed communications in the downlink direction, the UE 110 may transition to the RRC connected state. This may include establishing a beam pair between the UE 110 and the currently camped base station.

The UE 110 may also be configured to initiate beam management operations while configured with a connected discontinuous reception (C-DRX) cycle. For example, if no data is received for a predetermined amount of time, the UE 110 and the gNB 120A may configure a C-DRX cycle to conserve power at the UE 110. During the sleep mode of inactivity of the C-DRX cycle, the refined transmitter beam and the refined receiver beam of the beam pair are likely to become misaligned. As a result, beam management may be initiated. Accordingly, the exemplary beam management mechanisms may be implemented in these types of scenarios. However, the above scenarios are merely provided for illustrative purposes and the exemplary embodiments are not limited to any particular scenario. The exemplary embodiments may be used in conjunction with other currently implemented beam management mechanisms, future implementations of beam management mechanisms or independently from other beam management mechanisms.

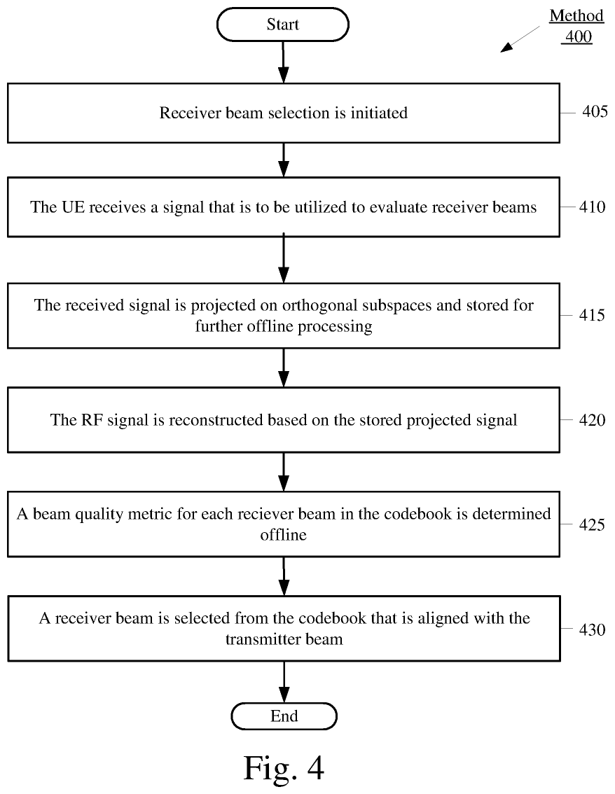

FIG. 4 shows an exemplary receiver beam selection method 400 according to various exemplary embodiments. The exemplary method 400 will be described with regard to the network arrangement 100 of FIG. 2 and the UE 110 of the FIG. 3.

In 405, receiver beam selection is initiated. Receiver beam selection is part of beam management and as indicated above, beam management may be performed in a wide variety of different scenarios. Receiver beam selection does not require the selected receiver beam to be utilized for a data transfer. In some scenarios, the receiver beam may be selected in anticipation of a possible event (e.g., a handover to a particular neighbor cell, cell selection, cell reselection, etc.) but for any of a plurality of different reasons the event does not actually occur. Accordingly, the selected receiver beam may not be used for a subsequent data transfer. The exemplary method 400 may apply to receiver beam selection being performed in any context and is not limited to any particular scenario.

In 410, the UE 110 receives a signal that is to be utilized to evaluate receiver beams. As will be described below, the signal is to be projected onto a predetermined signal space and stored for further processing offline. The exemplary embodiments are described with regard to the signal including a synchronization signal block (SSB) or a channel state information resource signal (CSI-RS). However, reference to SSB or CSI-RS is for illustrative purposes. Different networks and/or entities may refer to similar concepts by a different name. Accordingly, the exemplary embodiments may apply to the signal including any type of synchronization signal (e.g., primary synchronization signal (PSS), secondary synchronization signal (SSS), etc.), reference signal (e.g., demodulation reference signal (DMRS), phase tracking reference signal (PTRS), sounding reference signal (SRS), etc.), symbol, tone, bit, combination thereof, etc. that may be processed and projected onto the predetermined signal space.

The signal in 410 may be transmitted in any of multiple different scenarios. For example, in some exemplary embodiments, the signal may be transmitted by the currently camped base station (e.g., gNB 120A). In some exemplary scenarios, this may occur because the UE 110 is to transition from the RRC idle state to the RRC connected state to receive downlink data. Accordingly, the currently camped base station may be triggered to transmit the signal in 410 for beam management purposes. In another exemplary scenario, the UE 110 may be configured with a C-DRX cycle. The C-DRX cycle may include designated measurement opportunities where the signal is scheduled to be transmitted for beam management purposes. Accordingly, the currently camped base station may be triggered to transmit the signal in 410 during a scheduled measurement opportunity.

In other exemplary embodiments, the signal may be transmitted by a neighbor base station (e.g., gNB 120B). In one exemplary scenario, the neighbor base station may be configured to periodically broadcast the signal received in 410. During operation, the UE 110 may utilize a measurement gap to scan for signals broadcast by neighbor cells and receive the signal in 410. In another exemplary scenario, the UE 110 may scan for signals broadcast by neighbor cells during a measurement opportunity included in a C-DRX cycle.

The above referenced exemplary scenarios are not intended to limit the exemplary embodiments to the signal received in 410 being transmitted by any particular base station for any particular reason. During operation, the UE 110 may be triggered to scan for signals that may be utilized to evaluate receiver beams based on various factors, including but not limited to, a scheduled measurement opportunity, a scheduled measurement gap, an indication that a handover is imminent, an indication that performance of a beam pair with a serving base station is degrading, the occurrence of a predetermined condition, a timer, etc. The exemplary embodiments may apply receiver beam selection being performed in any appropriate context.

In 415, the received signal is projected on a signal subspace and stored for further offline processing. For example, the signal projection engine 235 may receive the signal in a digital format and then project the signal on a predetermined orthogonal signal space in a time distributed fashion. This allows the analog RF signal to be reconstructed for the offline beam search. To provide an example of how the received signal may be projected on the signal subspace, an exemplary arrangement 500 and an exemplary radio frequency (RF) channel are described below.

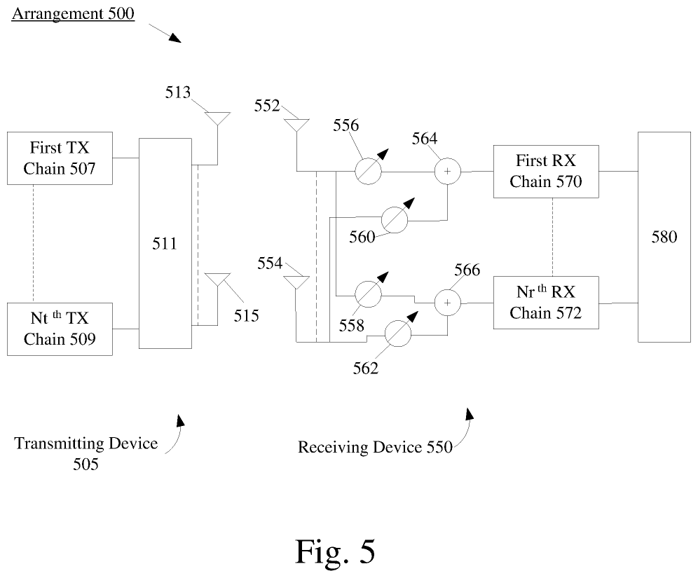

FIG. 5 shows an exemplary arrangement 500 of a transmitting device 505 and a receiving device 550 according to various exemplary embodiments. As will be described below, the RF channel between the transmitting device 505 and the receiving device 550 includes the analog signals exchanged over the air between the antenna elements of the devices 505, 550. On the receiving device 550 side, the signals received at each antenna element are converted to digital signals and provided to a baseband processor by a plurality of receiver (RX) chains. However, when the number of RX chains is less than the number of antenna elements at the receiving device 550, the baseband processor can only estimate the lower dimensional RX chain channel. To perform the receiver beam search offline, the analog signal from the antenna elements may be used. Accordingly, by projecting the digital signal received by the baseband processor onto a predetermined orthogonal signal space the higher dimensional analog signal may be reconstructed.

The transmitting device 505 includes a first transmitter (TX) chain 507 through a Nₜ-th TX chain 509. The TX chains 507 through 509 provide a signal to an analog transmit beamforming module 511 (e.g., beamformer) which is coupled to a first antenna element 513 through Mₜ-th antenna element 515. Accordingly, the RF channel between the transmitting device 505 and the receiving device 550 includes signals transmitted by Mₜ antenna elements.

The receiving device 550 includes a first antenna element 552 and an Mr-th antenna element 554. Each antenna element 552, 554 is coupled to various analog signal processing components. In this example, the antenna element 552 is coupled to a first phase shifter 556 and a second phase shifter 558. The Mr-th antenna element is coupled a third phase shifter 560 and a fourth phase shifter 562. The output of the first phase shifter 556 and the third phase shifter 560 is combined at a first mixer 564 and the output of the second phase shifter 558 is combined with the output of the fourth phase shifter 562 is combined at a second mixer 566. The output of the first mixer 564 is provided to a first receiver (RX) chain 570 and the output of the second mixer 566 is provided to a Nth RX chain 572. The first RX chain 570 and the Nth RX chain 572 may perform various signal processing operations such as a Discrete Fourier Transform (DFT) and then output the received signals to a baseband processor 580.

In this example of the receiving device 550, the number of antenna elements (Mᵣ) is greater than the number of RX chains (Nᵣ) represented as 570 through 572 in this example. Since the number of antenna elements is greater than the number of RX chains, the dimension of the received RF signal drops when it is provided to the RX chains 570, 572. Due to the nature of analog to digital signal processing, the analog signal from the antenna elements cannot be stored and the baseband processor 580 may only estimate the RX chain channel. Accordingly, the information processed by the baseband processor 580 may not accurately represent the higher dimensional RF channel. The exemplary embodiments relate to storing the signals projected on Mᵣ orthogonal subspaces so that the RF signal may be reconstructed for offline receiver beam search. The number of beams in the codebook is much larger than the number of antenna elements Mᵣ. Thus, the conventional method of sweeping and measuring all beams in the codebook requires more measurements than the exemplary embodiments' Mᵣ signal projections.

The exemplary embodiments may apply to any RF channel mode. In this description, let the time-domain RF channel be denoted by \tilde{H}. In accordance with a clustered delay channel (CDL) model, the time-domain RF may be represented by the following equation:

\tilde{H}=\sqrt{MₜMᵣ/L}Σ_{c=1}^{C}Σₗ₌₁^{L}g_{c,l}aᵣ(θ_{c,l})aₜ^{H}(∅_{c,l})

Here, the signal propagates from the Mₜ transmitter antenna elements at the transmitting device 505 through multiple (L) paths and the signals received by Mᵣ receiver antenna elements at the receiving device 550. Further, C represents the number of multipath clusters where a cluster refers to a set of multipaths having close propagation delays, L represents the number of multipaths per cluster where a path refers to the route through which a signal propagates, g_{c,l} represents channel gain for the L-th path of the c-th cluster, aᵣ represents the receive array response, (θ_{c,l}) represents the angle of arrival, aₜ^{H} represents the transmit array response and (∅_{c,l}) represents the angle of departure.

The RF signal received at an antenna element of the receiving device 550 for a transmitter beam j carrying a synchronization signal/reference signal (e.g., SSB, CSI-RS, etc.) may be represented by the following equation:

\tilde{y}_{m,n}^{(j)}=\sqrt{P_{power}}\tilde{H}\tilde{B}ⱼs_{m,n}+w_{m,n}

Here, P_{power} denotes transmitted signal power, \tilde{H} is the RF channel referenced above, \tilde{B}ⱼ represents the characteristics of the transmitter beam, s_{m,n} represents the transmitted reference symbols which are known at the receiver, w_{m,n} represents noise and interferences, m represents an OFDM symbol and n represents the time-domain sample index within the OFDM symbol duration.

The orthonormal vectors for probing the signal space is equal to the number of receiver antenna elements Mᵣ at the receiving device 550 and may be represented by the matrix columns shown in the following equation:

V=[V₁, . . . ,V_{M}_{ᵣ}]_{M}_{ᵣ}_{×M}_{ᵣ}

The orthonormal vectors may be based on the receiver beams included the codebook. However, orthonormal vectors that are not included in the codebook may also be available.

Returning to 415, projecting the received signal on the signal subspace may include projecting the received signal over Mᵣ symbols in a time distributed fashion which may be represented by the following equations:

Time Domain (TD): y_{m,n}^{(i,j)}=Vᵢ^{H}\tilde{y}_{m,n}^{(j)} where i=1, 2, . . . , Mᵣ

Frequency Domain (FD) symbol buffer after symbol projection and DFT: =Y_{m,k}^{(i,j)}=DFT[y_{m,n}^{(i,j)}]=Vᵢ^{H}\tilde{Y}_{m,k}^{(j)}, where DFT[\tilde{y}_{m,n}^{(j)}]=\tilde{Y}_{m,k}^{(j)} is the frequency domain representation of the RF signal.

Subsequently, the signature of the transmitted reference signal (e.g., PSS, SSS, DMRS, CSI-RS, etc.) is removed and a signal space projection vector is generated by the following equations:

Ŷₖ^{(i,j)}=Y_{m,k}^{(i,j)}*S*_{m,k}

Here, S_{m,k}=DFT[s_{m,n}] which is the transmitted frequency domain synchronization signal/reference signal mentioned above.

Ŷₖ^{(j)}=[Ŷₖ^{(l,j)}, . . . ,Ŷₖ^{(M}^{ᵣ}^{,j)}]^{T}=V^{H}(\sqrt{P_{power}}HBⱼ)+Ŵₖ

H is channel frequency response. Ŷₖ^{(j)} is averaged over k observations in the frequency domain to suppress noise and interference, this may be represented by the following equation:

$${\hat{Y}}^{( j )} = \frac{1}{k} {\sum }_{k = 1}^{K} {Y}_{k}^{( j )} \approx {V}^{H} ( \sqrt{{P}_{power}} {HB}_{j} )$$

This projected signal vector is stored in memory for subsequent processing. To reduce time for subspace projection, two orthonormal vectors may be utilized on two RX chains. This enables the same number of projected signals in half the measurement time. For example, four orthonormal projections may be generated in two OFDM symbols.

In 420, the RF signal is reconstructed \hat{R}^{(j)} based on the stored projected signal and stored in memory, where

$${\hat{R}}^{( j )} = {V}^{- H} {\hat{Y}}^{( j )} = [ \begin{matrix}{R}_{1}^{( j )} \\ ⋮ \\ {R}_{{M}_{r}}^{( j )}\end{matrix} ]$$

Here, the inversion Hermitian matrix V^{-H} is deterministic, precomputed and stored in memory beforehand.

In 425, a beam quality metric for each receiver beam in the codebook is determined offline. For example, consider the following exemplary scenario, the UE 110 is equipped with 4 antenna elements (e.g., Mᵣ=4), the codebook to be searched includes 42 receiver beams and the beam quality metric is reference signal received power (RSRP). However, reference to 42 receiver beams and RSRP is for illustrative purposes, a person of ordinary skill in the art would understand that other numbers of beams and metrics such as signal-to noise ratio (SNR) may be used. The beam quality metric for each receiver beam in the codebook may be determined by the following equation:

$${Q}_{42 x 1}^{( j )} = {\vert {W}_{42 x 4}^{H} {\hat{R}}_{4 x 1}^{( j )} \vert}^{2} = [ \begin{matrix}{Q}_{1}^{( j )} \\ ⋮ \\ {Q}_{{i}_{opt}}^{( j )} \\ ⋮ \\ {Q}_{42}^{( j )}\end{matrix} ]$$

Here, Qᵣ^{(j)} represents RSRP of the r-th receive beam (r=1, 2, . . . , 42) for the j-th transmit beam. A^{H} denotes Hermitian of a matrix A. The matrix W_{42×4} contains 42 receive beams and the preferred (such as, for example, optimal) receiver beam index (iₒₚₜ) is determined by the row index of Qᵢ_{ₒₚₜ}^{(j)} represented by the following equation:

$${i}_{opt} = arg {max}_{i} {Q}_{i}^{( j )} ,$$

Accordingly, in this example, the above equation includes 42 vector multiplications.

In 430, a receiver beam is selected from the codebook that is aligned with the transmit beam j. The receiver beam to be selected for transmit beam j is represented by wᵢ_{ₒₚₜ}^{(j)}=iₒₚₜ−th row of codebook matrix W_{42×4}. Once the receiver beam for each transmit beam j is determined, the transmit beam for the receiver is determined as

$${j}_{opt} = arg {max}_{j} {Q}_{{i}_{opt}}^{( j )}$$

Thus, by utilizing the method 400 including projecting the reference signal on a signal subspace and storing the projection for future use, the receiver beam may be selected from the codebook by performing the processing offline. This offline processing results in the limited time available for downlink data transfer not being interrupted to perform measurements for beam management purposes.

In the above example, the codebook is static and limits receiver beam selection to the predetermined number of receiver beams. In some exemplary embodiments, using the reconstructed signal in 420, the UE 110 may utilize dynamic beamforming where receiver beams that are not included in the codebook may be selected. Dynamic beamforming may rely on dynamic receiver beam coefficients for the transmit beam j. Exemplary dynamic receiver beam coefficients may be represented by the following equation:

$${\hat{w}}_{dyn}^{( j )} = [ \begin{matrix}∠ {R}_{1}^{( j )} \\ ⋮ \\ ∠ {R}_{{M}_{r}}^{( j )}\end{matrix} ] = \frac{1}{{\vert {R}^{( j )} \vert}^{2}} [ \begin{matrix}{R}_{1}^{{( {j}_{opt , dyn} )}^{*}} \\ ⋮ \\ {R}_{{M}_{r}}^{{( j )}^{*}}\end{matrix} ]$$

A preferred (such as, for example, optimal) transmit beam across received SSBs or CSI-RS may be represented by the following equation:

$${j}_{opt , dyn} = \begin{matrix}arg max {\vert {R}^{( j )} \vert}^{2} \\ j\end{matrix}$$

The global dynamic beam pair may be represented by the following equation:

$${\hat{w}}_{dyn}^{( {j}_{opt , dyn} )} = \frac{1}{{\vert {R}^{( j )} \vert}^{2}} [ \begin{matrix}{R}_{1}^{{( {j}_{opt , dyn} )}^{*}} \\ ⋮ \\ {R}_{{M}_{r}}^{{( {j}_{opt , dyn} )}^{*}}\end{matrix} ]$$

Whether the receiver beam is selected based on searching the dynamic codebook or performing dynamic beamforming, the offline processing enables a significant amount of potential receiver beams to be evaluated. For example, when utilizing the codebook, an exhaustive search of the entire codebook may be performed. Similarly, with regard to dynamic beamforming, an exhaustive search of beams may be performed which may include sweeping narrower beams (compared to beams in the codebook) at the lowest hierarchical level. To provide an example, a plurality of substantially overlapping beams may be evaluated to achieve a precise alignment.

Receiver beams may be configured with sidelobes that may be utilized for interference suppression. Thus, some receiver beams may be pointed in the same direction of interest but may be configured with different sidelobe directions. Accordingly, a beam sweep of these types of receiver beams may be performed offline using dynamic beamforming to select a receiver beam that may provide interference suppression. For example, the receiver beam may be selected based on signal-to-interference-plus-noise ratio (SINR) or reference signal receiver quality (RSRQ).

Dynamic beamforming may provide better performance compared to utilizing the static codebook because dynamic beamforming allows the AoA of the receiver beam to be centered on the transmitter beam.

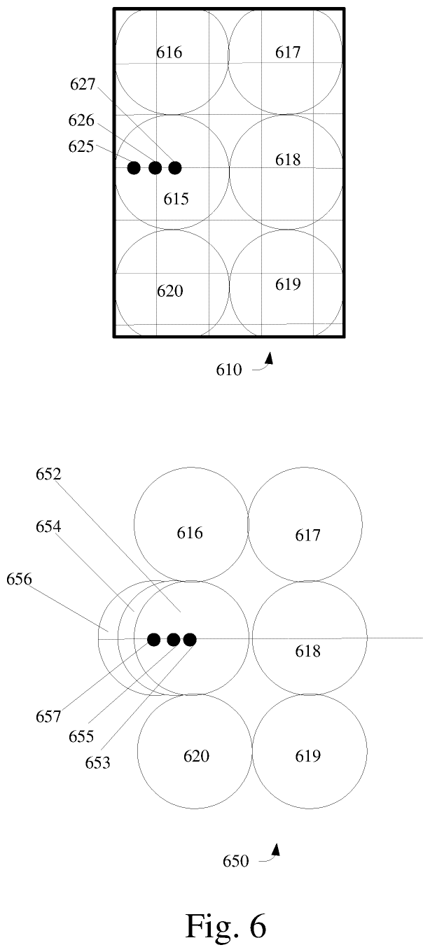

FIG. 6 shows an example of the configuration of the AoA for a receiver beam selected based on the codebook and an example of the configuration of the AoA for a dynamic receiver beam. In a first scenario 610, a receiver beam 615 is selected based on the codebook. The adjacent receiver beams 616, 617, 618, 619, 620 are provided to depict a portion of the codebook. Since the codebook is static and limits the receiver beam selection to the predetermined receiver beams, the AoA may be anywhere within the receiver beam 615. To provide an example, the three points 625, 626, 627 illustrate three possible AoAs.

In contrast, the second scenario 650 relates to dynamic beamforming. In this example, three overlapping receiver beams 652, 654, 656 are depicted. Since dynamic beamforming is not limited to the codebook a beam sweep may encompass a smaller spatial area compared to a beam sweep performed using the codebook. Thus, the receiver beam 652 may be centered around its AoA 653, the receiver beam 654 may be centered around its AoA 655 and the receiver beam 656 may be centered around its AoA 657. The adjacent receiver beams 616, 617, 618, 619, 620 are provided to depict a comparison to the codebook. Accordingly, the receiver beam that is aligned with the transmitter beams angle of arrival may be selected. This provides an increase in gain over the static codebook selection and allows fine adjustments to be made to the receiver beam based on channel variations.

Receiver beam selection based on the static codebook and dynamic beamforming may both be able to track rotation relative to the transmission point without sensor input if sufficient measurement data is available. However, if sufficient measurement data is not available, only dynamic beamforming may track rotation relative to the transmission point based on sensor input.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
at a user equipment (UE):
receiving a radio frequency signal comprising a reference signal, wherein the radio frequency signal corresponds to a transmitter beam;
projecting the radio frequency signal on orthogonal signal subspaces and storing the projected signals; and
performing a beam search to identify a receiver beam for the transmitter beam using the projected signals, wherein the beam search is performed offline.

2. The method of claim 1, wherein the beam search is based on a plurality of receiver beams included in a codebook.

3. The method of claim 2, wherein performing the beam search comprises selecting a beam quality metric for each receiver beam in the codebook.

4. The method of claim 3, wherein the receiver beam is identified based on at least the beam quality metric.

5. The method of claim 1, wherein the beam search is based on a plurality of receiver beams stored in a codebook and a further plurality of receiver beams that are not included in the codebook.

6. The method of claim 5, wherein the further plurality of receiver beams is based on an angle of arrival (AoA) relative to an antenna array.

7. The method of claim 1, wherein performing the beam search comprises reconstructing a radiofrequency signal from the stored projected signals.

8. A user equipment (UE), comprising:
a plurality of antennas configured to receive a radio frequency signal comprising a reference signal and corresponding to a transmitter beam;
a plurality of receive chains, wherein a number of receive chains is less than a number of antennas; and
a baseband processor configured to perform operations comprising:
receiving the radio frequency signal;
projecting the radio frequency signal on orthogonal signal subspaces and storing the projected signals; and
performing a beam search to identify a receiver beam for the transmitter beam using the projected signals, wherein the beam search is performed offline.

9. The UE of claim 8, wherein the beam search is based on a plurality of receiver beams included in a codebook.

10. The UE of claim 9, wherein performing the beam search comprises selecting a beam quality metric for each receiver beam in the codebook.

11. The UE of claim 10, wherein the receiver beam is identified based on at least the beam quality metric.

12. The UE of claim 8, wherein the beam search is based on a plurality of receiver beams stored in a codebook and a further plurality of receiver beams that are not included in the codebook.

13. The UE of claim 12, wherein the further plurality of receiver beams is based on an angle of arrival (AoA) relative to an antenna array comprising a portion of the plurality of antennas.

14. The UE of claim 8, wherein performing the beam search comprises reconstructing a radio frequency channel from the stored projected signals.

15. A baseband processor configured to perform operations comprising:
receiving a radio frequency signal comprising a reference signal, wherein the radio frequency signal corresponds to a transmitter beam;
projecting the radio frequency signal on orthogonal signal subspaces and storing the projected signals; and
performing a beam search to identify a receiver beam for the transmitter beam using the projected signals, wherein the beam search is performed offline.

16. The baseband processor of claim 15, wherein the beam search is based on a plurality of receiver beams included in a codebook.

17. The baseband processor of claim 16, wherein performing the beam search comprises selecting a beam quality metric for each receiver beam in the codebook.

18. The baseband processor of claim 17, wherein the receiver beam is identified based on at least the beam quality metric.

19. The baseband processor of claim 15, wherein the beam search is based on a plurality of receiver beams stored in a codebook and a further plurality of receiver beams that are not included in the codebook.

20. The baseband processor of claim 19, wherein the further plurality of receiver beams is based on an angle of arrival (AoA) relative to an antenna array.
